(19) United States
(12) Patent Application Publication
(10) Pub. No.: US 2008/0167820 A1
(43) Pub. Date: Jul. 10, 2008

(54) SYSTEM FOR PREDICTING DRIVER BEHAVIOR

(76) Inventors: Kentaro Oguchi, Ichinomiya (JP); David Weir, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/968,864

(22) Filed: Jan. 3, 2008

Related U.S. Application Data
(60) Provisional application No. 60/883,452, filed on Jan. 4, 2007.

(51) Int. Cl. G08G 1/16; G06F 17/10

(52) U.S. Cl. 701/301

(57) ABSTRACT

A system and method for predicting driver behavior and generating control and/or warning signals comprises: one or more sensors; a database; a driver predictor for generating warning and control signals; a notification unit; and a vehicle control unit. More specifically, the driver predictor includes a transfer module, a hierarchical temporal memory and a prediction retrieval module. The transfer module is used to receive data and translate it into a form so that it can be stored in the hierarchical temporal memory. The hierarchical temporal memory receives data input and stores it such that data items are translated into short-term memory items which are in turn translated into intermediate-term data which in turn are finally translated into long-term data. The translation of data from one level of the memory to another is performed according to the present invention such that the data at each level of memory is reflective of and predictive of a particular driver behavior. Once the data is stored in the memory, the prediction retrieval module accesses the hierarchical temporal memory to generate warning signals to alert the driver of potentially dangerous conditions and/or control systems of the vehicle to prevent or avoid collisions. The present invention also includes a variety of method including a method for storing driving data in a hierarchical temporal memory, and a method for using a hierarchical temporal memory to generate collision avoidance signals.

### CROSS-REFERENCE TO RELATED APPLICATIONS

This application claims the benefit under 35 U.S.C. § 119(e) of provisional patent application Ser. No. 60/883,452 filed Jan. 4, 2007 by the present inventors.

### BACKGROUND OF THE INVENTION

1. Field of the Invention

The present invention relates to vehicle movement and behavior, and in particular, to a system for predicting vehicle movement or behavior. Still more particularly, the present invention relates to systems and methods of predicting vehicle movement or behavior of other vehicles in the proximity of a primary vehicle.

2. Description of the Background Art

The prior art includes a variety of systems related to collision detection or crash warning. Many receive sensor signals and determine whether the signals are greater than a threshold, and if so they send a warning or send a control signal to modify operation of the vehicle. However, one problem with such prior art methods is that fixed thresholds produce either too many false positives or not enough warning. Thus, their overall reliability and effectiveness is limited which has precluded their adoption.

Another problem is that predicting the conditions that are likely to result in a collision is a very complicated computation. There have been attempts to predict crashes from vehicle location and direction. For example, the prior art has attempted to predict vehicle behavior using neural networks such as in the “Neuroevolution of an Automobile Crash Warning System” by K Stanley, N. Khol, R. Sherony and R. Mikkulainen. These techniques use neural networks by evolving network topology to learn object models. Using neuroevolution of augmenting topologies, a system can automatically create a neural network topology and determine estimated duration and predict imminent collisions. However, the problem with using neural networks in this way is that the predictions are not accurate because there is no way to include user intention or driving habits in the models.

Therefore, what are needed are systems and methods for predicting the behavior of other vehicles in the proximity of a primary vehicle.

### SUMMARY OF THE INVENTION

The present invention overcomes the deficiencies and limitations of the prior art by providing a system and method for predicting driver behavior and generating control and/or warning signals. In one embodiment, the system comprises: one or more sensors; a database; a driver predictor for generating warning and control signals; a notification unit; and a vehicle control unit. More specifically, the driver predictor includes a transfer module, a hierarchical temporal memory and a prediction retrieval module. The transfer module is used to receive data and translate it into a form so that it can be stored in the hierarchical temporal memory. The hierarchical temporal memory advantageously includes three levels of memory one for short-term, one for intermediate term and one for long term. The hierarchical temporal memory advantageously receives data input and stores it such that data items are translated into short-term memory items which are in turn translated into intermediate-term data which in turn are finally translated into long-term data. The translation of data from one level of the memory to another is performed according to the present invention such that the data at each level of memory is reflective of and predictive of a particular driver behavior. Once the data is stored in the memory, the prediction retrieval module accesses the hierarchical temporal memory to generate warning signals to alert the driver of potentially dangerous conditions and/or control systems of the vehicle to prevent or avoid collisions. The present invention also includes a variety of method including a method for storing driving data in a hierarchical temporal memory, and a method for using a hierarchical temporal memory to generate collision avoidance signals.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is a high-level block diagram illustrating a functional view of a driver behavior prediction system according to one embodiment of the present invention.

FIG. 2 is a block diagram illustrating a functional view of a driver predictor system according to one embodiment of the present invention.

FIG. 3 is a block diagram illustrating a functional view of a hierarchical temporal memory according to one embodiment of the present invention.

FIG. 4 is a diagram representing an example vehicle on a road and showing related data and short paths according to one embodiment of the present invention.

FIG. 5 is a diagram representing an example vehicle on a road and showing related trajectory according to one embodiment of the present invention.

FIG. 6 is a block diagram illustrating a functional view of a prediction retrieval module according to one embodiment of the present invention.

FIG. 7 is a flowchart illustrating a process for predicting driver behavior according to one embodiment of the present invention.

### DETAILED DESCRIPTION OF THE PREFERRED EMBODIMENTS

A system and method for predicting driver behavior and generating control and/or warning signals is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention is described in one embodiment below with reference to a java, user interfaces and particular hardware. However, the present invention applies to any type of computing device that can receive a data and commands, and any peripheral devices providing services.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

### System Overview

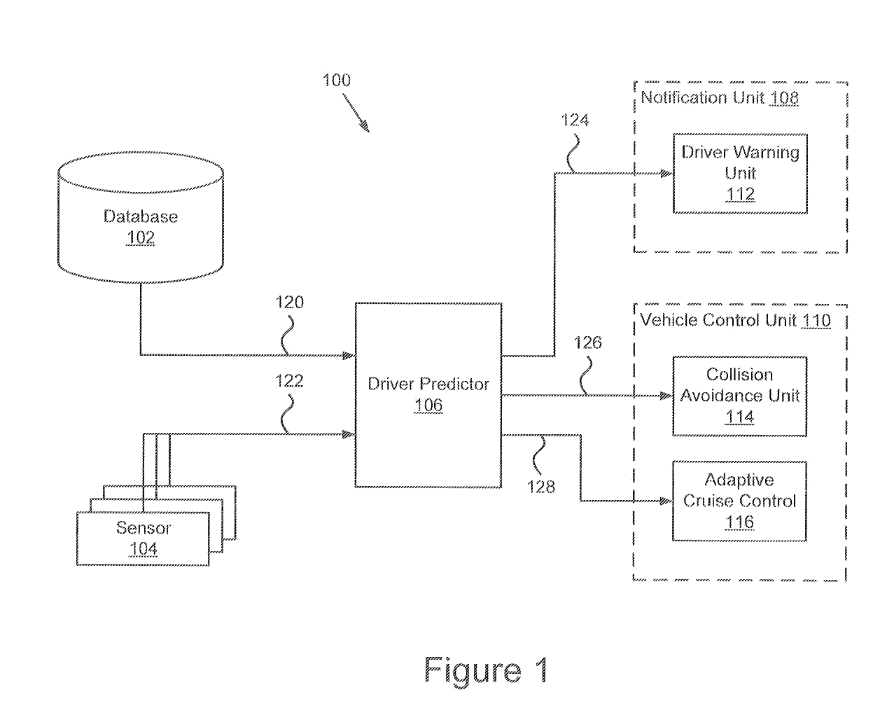

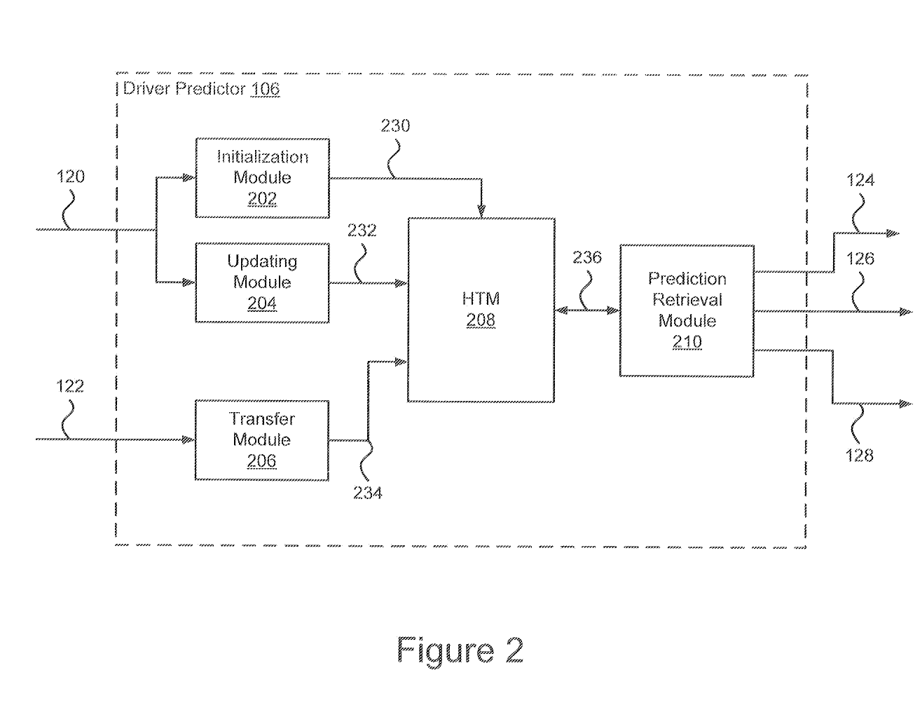

Referring now to FIG. 1, a system and method for predicting driver behavior and generating control and/or warning signals will be described. In one embodiment, a system 100 comprises: one or more sensors 104; a database 102; a driver predictor 106 for generating warning and control signals; a notification unit 108; and a vehicle control unit 110. The system 100 employs a vehicle behavior prediction algorithm to predict short-term and long-term driving behavior based upon current driving patterns and a history of driving patterns. The present invention is particularly advantageous because the driver predictor 106 includes a hierarchical temporal memory 208 (See FIG. 2). Using this hierarchical temporal memory 208, the system 100 observes and learns the short term, midterm and long-term vehicle behavior; and from the learned temporal behavior model, the system 100 predicts the short-term midterm and long-term behavior of other vehicles. The predicted behavior produced by the system 100 can in turn be used to control the notification unit 108 and the vehicle control unit 110.

The one or more sensors 104 are of a conventional type for measuring conditions external to the vehicle (not shown) in which the system 100 operates. In one embodiment, the system 100 uses only a single sensor 104. However, in the preferred embodiment, the system 100 receives data from a plurality of sensors 104. For example, the sensors 104 measure the proximity, direction, speed and acceleration of other vehicles using RADAR, LIDAR, cameras, infrared detectors, motion detectors or any other type of conventional sensor. Furthermore, the sensors can include measurements of vehicle in which the system 100 resides such as speed, vehicle direction, external temperature, etc. Those skilled in the art will recognize that even though the present invention will be described below primarily with reference to the sensors 104 inputting data about the position and speed of other vehicles, in alternative embodiments, the system 100 receives input from a variety of other sensors related to vehicle operation in which the system 100 such as whether the brake pedal is being depressed, the amount of steering applied by the driver, whether the accelerator is being depressed, whether any of the other functions of the vehicle are being operated such as signals, emergency lights, headlights, horn, windshield wipers, etc.

The database 102 is a conventional type such as a relational database or a flat file database. In one embodiment, the database 102 stores and historical information that can be used by the driver predictor 106 to create a prediction model. More specifically, the information stored in the database 102 is used to initialize the driver predictor 106 and establish categories or types within the different levels of the hierarchical temporal memory 208, as will be explained in more detail below. The database 102 can also include other information used by the driver predictor 106 for updating the hierarchical temporal memory 208 such as but not limited to geographic information, demographic information, personal preferences, etc. In essence, the database 102 each used to store any information used by the driver predictor 106.

The driver predictor 106 generates warning and control signals. The driver predictor 106 is coupled by signal line 120 to the database 102 to receive information that it uses to update or initialize its hierarchical temporal memory 208 (See FIG. 2). The driver predictor 106 is also coupled to signal line 122 to the plurality of sensors 104 to receive data input from the sensors 104. The driver predictor 106 employs a prediction algorithm to determine likely positions of other vehicles in the proximity of the vehicle in which the system 100 is operational. The driver predictor 106 advantageously uses the hierarchical temporal memory 208 to create a learned temporal behavioral model. The model is particularly advantageous because it has an understanding time and it can encode new information with that understanding of time. The driver predictor 106 is described in more detail below with reference to FIG. 2. The hierarchical temporal memory 208 can be accessed and used to generate a variety of signals for alerting the driver of dangerous conditions or signals for controlling the operation of the vehicle. In one embodiment, the driver predictor 106 includes a first output coupled by signal line 124 to the notification unit 108 and a second and third output coupled by signal lines 126, 128 respectively, to the vehicle control unit 110.

The notification unit 108 is a conventional type and includes a driver warning unit 112. For example, the notification unit 108 may be part of the conventional vehicle instrument panel that advises the driver about conditions related to the vehicle. In one embodiment, the driver warning unit 112 outputs sounds such as warning signals or verbal information. In another embodiment, the driver warning unit 112 outputs visual signals notifying the driver of hazardous conditions. For example, the driver warning unit 112 has three levels of notification: a low level, an intermediate level and a high level. For each of the levels, the driver warning unit 112 notifies the driver both visually and audibly of a possible collision condition. Additionally, the driver warning unit 112 includes in the notification an indication as to which of four areas (front left, front right, rear left or rear right) the collision is predicted. Those of ordinary skill in the art will recognize that any number of different driver warning or notification systems may be employed in conjunction with the present invention.

The vehicle control unit 110 is also coupled to the driver predictor 106. In one embodiment, the vehicle control unit 110 includes a collision avoidance unit 114 and an adaptive cruise control 116. The collision avoidance unit 114 is coupled to the driver predictor 106 by signal line 126. The collision avoidance unit 114 is of a conventional type, and responsive to the control signal received on signal line 126, intervenes with vehicle control such as by decelerating, accelerating or changing direction to reduce the impact of collision or avoid a collision entirely. The adaptive cruise control 116 is also coupled to the drive predictor 106 via signal line 128. The adaptive cruise control 116 is similar to conventional systems as will be known to those skilled in the art; however, the adaptive cruise control 116 also receives input from the driver predictor 106. The adaptive cruise control 116 uses the input from the driver predictor 106 along with other inputs such as from radar to control the position of the vehicle relative to other vehicles in front of or adjacent to the vehicle. Those skilled in the art will recognize that the output of the driver predictor 106 can also be input to any variety of other vehicle control systems. The collision avoidance unit 114 and the adaptive cruise control 116 are used here only by way of example.

### Driver Predictor

Referring now to FIG. 2, one embodiment of the driver predictor 106 is shown in more detail. The driver predictor 106 comprises an initialization module 202, an updating module 204, a transfer module 206, a hierarchical temporal memory 208 and a prediction retrieval module 210. The initialization module 202 and the updating model 204 are used to condition the hierarchical temporal memory 208 for use. During actual operation, the transfer module 206 receives real-time data and translates it into a form usable by the hierarchical temporal memory 208. At any time, the prediction retrieval module 210 can access and retrieve information from the hierarchical temporal memory 208. The information stored in the hierarchical temporal memory 208 is indicative of a current state of the vehicle and other vehicles surrounding it. Using predicted states stored in the hierarchical temporal memory 208, the prediction retrieval module 210 generates and outputs notification and warning signals appropriate for the current state.

The initialization module 202 has an input coupled to signal line 120 for exchanging data with database 102 and an output coupled to signal line 230 to provide data to the hierarchical temporal memory 208. In one embodiment, the initialization module 202 receives historical information about a variety of driving patterns of other vehicles and signals such driving patterns would generate by sensors 104 of the vehicle. The initialization module 202 processes the data from the database 102 and uses it to create initial states or definitions for different driver behaviors in the hierarchical temporal memory 208. In essence, historical data from the database 102 is input to the hierarchical temporal memory 208 under compressed time conditions. The application of this historical data to the hierarchical temporal memory 208 creates behavior definitions and each level in the hierarchical temporal memory 208.

The updating module 204 has an input coupled to signal line 120 for retrieving data from database 102. The output of the updating module 204 is coupled by signal line 232 to an input of hierarchical temporal memory 208. The updating module 204 retrieves standard information such as geographical information, demographic information, personal information and preferences from the database 102. The updating module 204 processes this information into format usable by the hierarchical temporal memory 208 and inputs it via signal line 232. The updating module 204 adapts the hierarchical temporal memory 208 to the specific driver of the vehicle. An individual driver may have particular driving habits and preferences that will affect the hierarchical temporal memory 208. For example, if the driver is an aggressive driver the hierarchical temporal memory 208 may be more sensitive to be movements of other vehicles. On the other hand, if the driver is a cautious driver, the hierarchical temporal memory 208 may be less sensitive to the movements of other vehicles. The updating module 204 inputs data to the hierarchical temporal memory 208 to condition it so that it matches the driver of the vehicle.

The transfer module 206 receives data and translates it into a form so that it can be stored in the hierarchical temporal memory 208. While only a single signal line 122 is shown, those skilled in the art will recognize that the transfer module 206 may receive a plurality of different signals from a plurality of sensors. The transfer module 206 has an input coupled to signal line 122 to receive real-time data from sensors 104. Since the sensors 104 may output data in a variety of different formats, the transfer module 206 standardizes the format of the information and inputs it via signal line 234 to the hierarchical temporal memory 208. For example, the transfer module 206 processes the data to remove noise, remove tracking information or ensure that the data is associated with the same vehicle. The information from the transfer module 206 is received and stored at the lowest level in the hierarchical temporal memory 208.

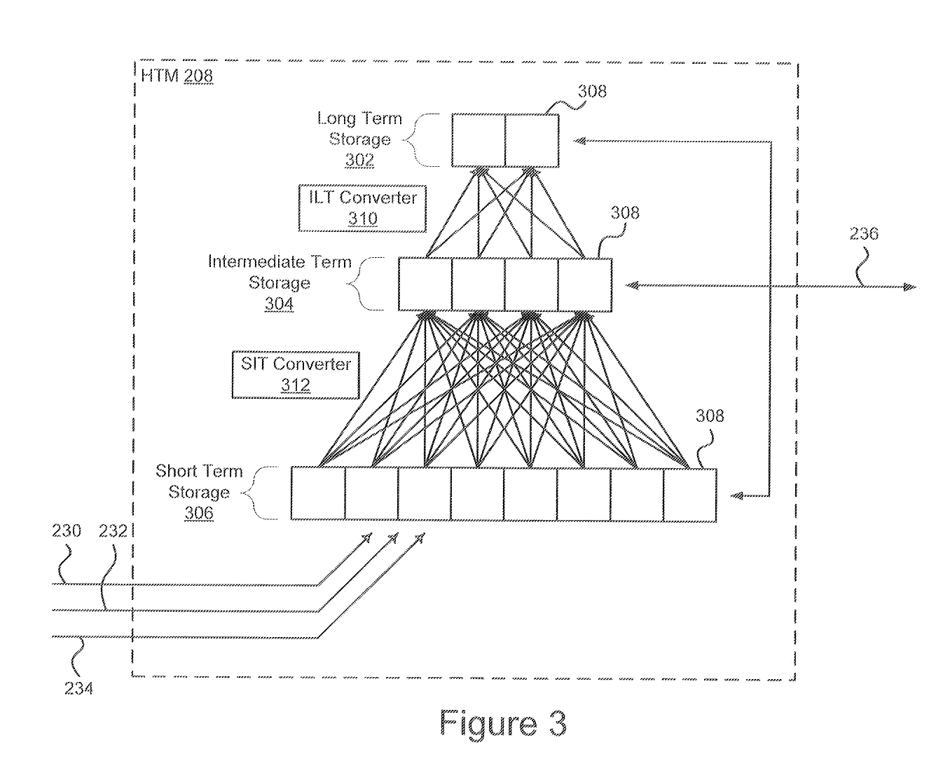

The hierarchical temporal memory 208 advantageously includes three levels one for short-term, one for intermediate term and one for long term. The hierarchical temporal memory 208 advantageously receives data input on signal lines 230, 232 and 234 from the initialization module 202, the updating module 204 and the transfer module 206, respectively, and stores it such that data items are translated into short-term memory items which are in turn translated into intermediate-tenm data which in turn are finally translated into long-term data. The translation of data from one level of the hierarchical temporal memory 208 to another is performed according to the present invention such that the data at each level of the hierarchical temporal memory 208 is reflective of and predictive of a particular driver behavior. Once the data is stored in the hierarchical temporal memory 208, the prediction retrieval module accesses the hierarchical temporal memory 208 to generate warning signals to alert the driver of potentially dangerous conditions and/or control systems of the vehicle to prevent or avoid collisions. The hierarchical temporal memory 208 is described in more detail below with reference to FIG. 3.

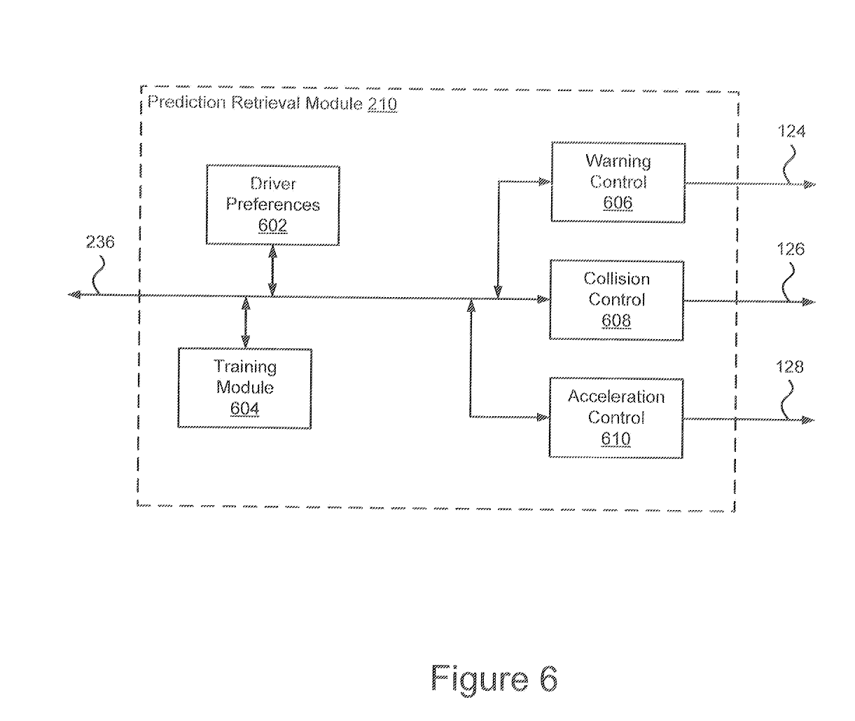

The prediction retrieval module 210 is coupled to the hierarchical temporal memory 208 by signal line 236. The prediction retrieval module 210 accesses the hierarchical temporal memory 208 to determine the predicted behavior of other vehicles. According to one embodiment, the prediction retrieval module 210 outputs a warning signal on signal line 124 and control signals on single lines 126 and 128. The prediction retrieval module 210 will be described in more detail below with reference to FIG. 6.

### Hierarchical Temporal Memory

Referring now to FIG. 3, the hierarchical temporal memory 208 is shown in more detail. According to one embodiment, the hierarchical temporal memory 208 comprises long-term storage 302, intermediate-term storage 304, short-term storage 306, an intermediate-to-long-term converter 310 and a short-to-intermediate-term converter 312. As has been noted above, the hierarchical temporal memory 208 is a memory mechanism with a hierarchical structure of temporal memory based on the memory mechanism the human brain. In hierarchical temporal memory, the memory is implemented as a temporal data sequence, and structured in a hierarchy so that the hierarchical temporal memory 208 can memorize short term, middle term and long term temporal event sequences. The hierarchical temporal memory 208 preferably uses a hierarchical temporal memory construct for vehicle behavior prediction. By inputting behavior of cars currently proximate the vehicle of interest, e.g., the motion of the cars, into the lowest layer (short-term storage 306) and performing learning and prediction in each layer in the hierarchy, the hierarchical temporal memory 208 can predict imminent action in the lowest layer (short-term storage 306), predict the intention such as a car is changing lanes in the middle layer (intermediate-term storage 304), and predict driving habits in the top layer (long-term storage 302). While the present invention has and will be described with the hierarchical temporal memory 208 including three levels, this is only by way of example. In a minimum embodiment, the hierarchical temporal memory 208 only has two levels. In other embodiments, the hierarchical temporal memory 208 has many levels more than three. Those skilled in the art will recognize that the hierarchical temporal memory 208 may be adapted to have as many levels necessary from providing increased accuracy for its specific intended use.

The long-term storage 302 is a plurality of cells or blocks 308 for storing behavior types. The cells or blocks 308 have a temporal arrangement such as ordered left to right. The long-term storage 302 is adapted for communication by signal line 236 to the prediction retrieval module 210. The long-term storage 302 is also coupled to the intermediate term storage 304 and the intermediate-to-long-term converter 310. As indicated by the arrows between the intermediate term storage 304 and the long-term source 302 in FIG. 3, the intermediate-to-long-term converter 310 generates behavior types for storage in the long-term storage 302 based on patterns of data stored in the intermediate term storage 304. In one embodiment, each behavior type is defined by an amount of time such is less than or equal to a minute; and multiple types of intermediate-term entries. In accordance with one embodiment of the present invention, the behavior types include a plurality of characterizations for driving behavior. For example, behavior types include: an aggressive driver, a lane changer, a tailgater, a slow wanderer, a speeder, a wanderer, a normal driver and an erratic driver. Each of these behavioral types has intermediate-term entries associated with it. Based on the intermediate-term entries that occur within a given timeframe, the intermediate-to-long-term converter 310 translates the entries in the intermediate term storage 304 and generates behavior types for storage in the long term storage 302.

The intermediate-term storage 304 is a plurality of cells or blocks 308 for storing trajectory types. The cells or blocks 308 have a temporal arrangement such as ordered left to right. The intermediate-term storage 304 is adapted for communication by signal line 236 to the prediction retrieval module 210. The intermediate term storage 304 is also coupled to the short-term storage 306, the long-term storage 302, the intermediate-to-long-term converter 310 and the short-to-intermediate-term converter 312. As indicated by the arrows between the short-term storage 306 and the intermediate term storage 304, the short-to-intermediate-term converter 312 generates trajectory types for storage in the intermediate term storage 304 based on patterns of data stored in the short-term storage 306. In one embodiment, each trajectory type is defined by an amount of time, such as less than 30 seconds; and multiple types of vehicle actions (e.g., short-term data entries). In one embodiment of the present invention, the trajectory types include a plurality of definitions for vehicle trajectory or action. For example, trajectory types include: parallel lane slow, parallel lane same speed, parallel lane passing, left lane change slow, left lane change normal, left lane change fast, right lane change slow, right lane change normal, right lane change fast, merge/on-ramp, merge/off-ramp, severe lane change, severe braking and severe acceleration. Each of these trajectory types has one or more short-term data entries associated with it. Based on the short-term entries in the short-term storage 306, the short-to-intermediate-term converter 312 translates the entries in the short-term storage 306 and generates trajectory types for storage in the intermediate term storage 304.

The short-term storage 306 is a plurality of cells or blocks 308 for storing short paths of vehicle action. The cells or blocks 308 have a temporal arrangement such as ordered left to right. The short-term storage 306 is adapted for communication by signal line 236 to the prediction retrieval module 210. The short-term storage 306 is also coupled to the intermediate-term storage 304, the short-to-intermediate-term converter 312 and the transfer module 206. As indicated by the signal lines 230, 232 and 234 between the short-term storage 306 and the transfer module 206, the transfer module 206 generates short paths for storage in the short-term storage 306 based on patterns of data received in real time or from the database 102 during initialization or updating. In one embodiment, a short path is defined by an amount of time, such as less than 10 seconds; and multiple types of real-time atomic attributes such as vehicle speed, vehicle position and vehicle acceleration/deceleration. Other atomic attributes include position such as determined by GPS and control input of the primary vehicle (e.g., braking, acceleration or turning). Essentially, the data indicates where other vehicles are at given times. In one embodiment of the present invention, the short paths include a plurality of definitions for vehicle speed, position and direction relative to the primary vehicle interest. For example, short paths include: on path, lane deviation, lane deviation type A, lane deviation type B, lane deviation type C and lane change. Based on the real-time data received by the transfer module 206, to transfer module 206 converts the raw data or atomic attributes into short paths and stores them in the short-term storage 306.

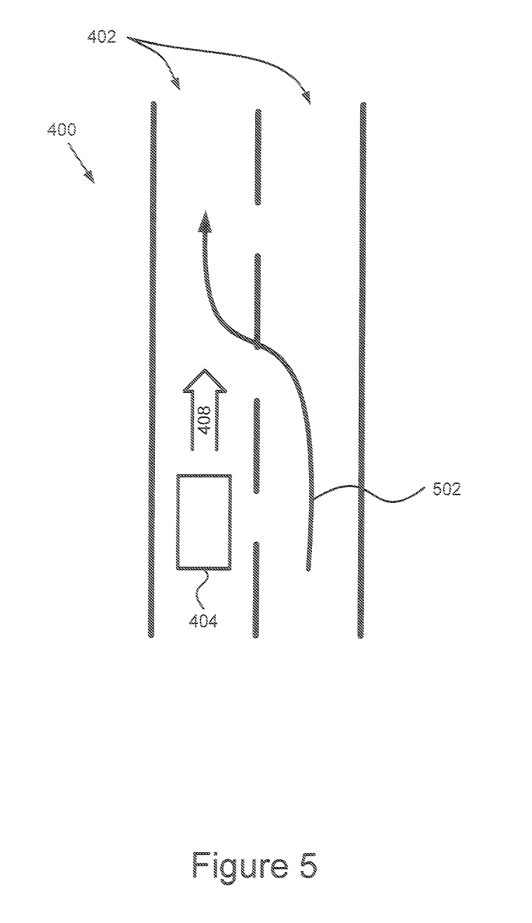

The intermediate-to-long-term converter 310 is software and routines for converting one or more trajectory types to a behavior type. As has been described above, the intermediate-to-long-term converter 310 communicates with the intermediate term storage 304 and the long-term storage 302. The intermediate-to-long-term converter 310 retrieves entries from the intermediate term storage 304, processes them to produce behavioral types and stores the behavioral types in the long term storage 302. In one embodiment, the intermediate-to-long-term converter 310 is operational once the hierarchical temporal memory 208 has been activated, and automatically accesses the intermediate-term storage 304 and generates and stores the new behavioral types into the long-term storage 302 on the systematic and periodic basis. The intermediate-to-long-term converter 310 can be better understood with reference to FIG. 5 below.

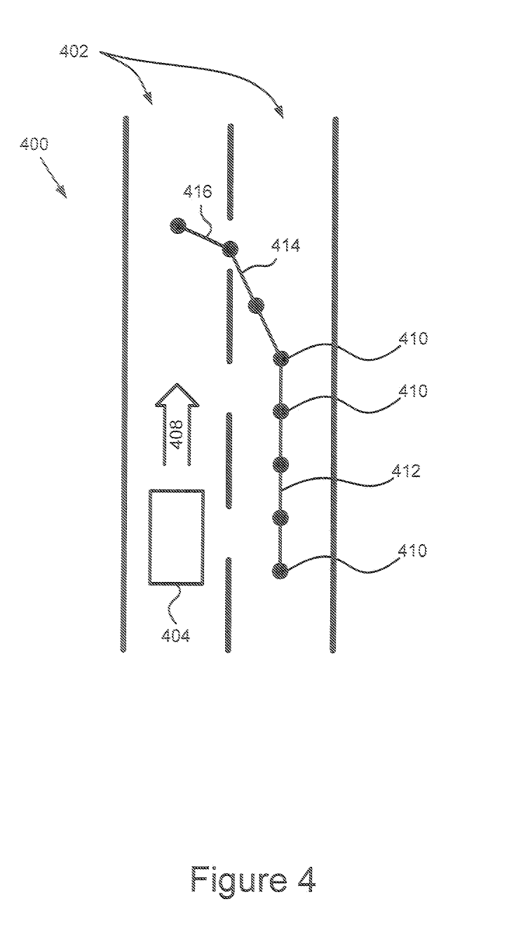

The short-to-intermediate-term converter 312 is software and routines for converting one or more short paths into trajectory types. As described above, the short-to-intermediate-term converter 312 communicates with the intermediate term storage 304 and the short-term storage 306. The short-to-intermediate-term converter 312 retrieves entries from the short-term storage 306, processes them to produce trajectory types and stores the trajectory types in the intermediate-term storage 304. Like the intermediate-to-long-term converter 310, the short-to-intermediate-term converter 312 is operational once the hierarchical temporal memory 208 has been activated and automatically accesses, generates and stores trajectory types into the intermediate term storage 304 on a systematic and periodic basis. The short-to-intermediate-term converter 312 can be better understood with reference to FIG. 4 below.

Referring now to FIG. 4, a graphic presentation 400 of a vehicle 404 traveling in a direction 408 in the left lane 402 of a road is shown. FIG. 4 is used to illustrate an example of how the hierarchical temporal memory 208 of the present invention receives input data and converts the input data to short-term paths. More specifically, this is an example to illustrate how raw data gathered by the vehicle 404 is processed by the transfer module 206 to generate short paths for storage in short term storage 306. The raw data input to the transfer module 206 is shown in this graphical depiction as a series of points 410. The points 410 are shown in FIG. 4 in the order that they are received. In one embodiment, the transfer module 206 processes the points as they are received, and processes points two at a time to generate the plurality of short paths 412, 414 and 416. As can be seen in FIG. 4, initially the paths between the first four points are normal paths 412 where the other vehicle is remaining in its lane. As the four points are processed, the transfer module 206 stores a short path entry into the short term storage 306 of the hierarchical temporal memory 208. Thus after the four points been processed, there would be three entries each being normal path 412 in the short-term storage 306. As additional points are processed, additional short paths are stored in the short-term storage 306 of the hierarchical temporal memory 208. For the processing of the remaining points, there would be three additional entries in the short-term storage 306. The next two entries would be a lane deviation type A 414 followed by a final entry of severe lane deviation 416. This example illustrates how the transfer module 206 is able to process the raw data to create short paths and store them in the short-term storage 306.

Referring now also to FIG. 5 in addition to FIG. 4, an example trajectory 502 is shown. The intermediate-to-long-term converter 310 processes the short paths described above with reference to FIG. 4 and produces trajectory 502 of FIG. 5. The trajectory 502 is processed and stored in the intermediate term storage 304 as a “left lane change fast” because of the types of short paths that comprise the trajectory 502. Those skilled in the art will recognize that different sets of short paths can be equated with different trajectories such that for each of the trajectories identified above there can be corresponding set of short paths. Since the hierarchical temporal memory 208 stores the short paths in the time order in which they were produced, the trajectories are defined not only by the set of short paths but also by the order of the short paths. Those skilled in the art will recognize that in a similar fashion, the intermediate-to-long-term converter 310 operates to generate a behavior type from one or more trajectories. For example, an aggressive driver may be defined as another vehicle that has one severe braking trajectory, one severe acceleration trajectory, and two lane changes within a predefined amount time. Another example is that a normal driver may have no severe braking, no severe acceleration and no wandering within a predefined length of time. Yet another example is that a lane changer may be characterized by no severe braking trajectories, no severe acceleration trajectories and three or more lane changes within a pre-defined amount of time. Those skilled in the art will recognize that each of the behavior types may be associated with one or more trajectories and the order of those trajectories.

### Prediction Retrieval Module

Referring now to FIG. 6, the prediction retrieval module 210 will be described in more detail. The prediction retrieval module 210 comprises a storage 602 for driver preferences, a training module 604, a warning control module 606, a collision control module 608, and acceleration control module 610. Each of these modules 602, 604, 606, 608 and 610 is coupled to signal line 236 to access and retrieve data from the hierarchical temporal memory 208. The prediction retrieval module 210 queries the hierarchical temporal memory 208 and generates warning and control signals on signal lines 124, 126 and 128. Since the hierarchical temporal memory 208 receives and stores prediction information for other vehicles in the short-term, the middle term and the long term, the prediction retrieval module 210 is able to predict the actions of other vehicles, such as a car cutting into the lane just in front of primary vehicle from the long term frequently change behavior which is not possible with existing technologies of the prior art.

The storage 602 for driver preferences is coupled to a signal line 236 to receive and send information to the hierarchical temporal memory 208 as well as the other modules 604, 606, 608 and 610 of the prediction retrieval module 210. In one embodiment, the storage 602 stores information that can be used to initialize and establish the operation of the other modules 604, 606, 608 and 610. For example, the storage 602 contains sample sets of preferences for different kinds of drivers. Each driver of the vehicle can modify these preferences to suit their own style of driving, these modified preferences are also be stored in module 602. Typical preferences stored in module 602 include the types and levels of settings for warning control, collision control and acceleration control.

The training module 604 is software and routines for training the warning control module 606, the collision control module 608 and acceleration control module 610. The training module 604 is coupled to signal line 236 for communication with the warning control module 606, the collision control module 608 and the acceleration control module 610. The training module 604 is used to initialize the condition the warning control module 606, the collision control module 608 and the acceleration control module 610. The training module 604 is used to help these modules 606, 608 and 610 to retrieve information from the hierarchical temporal memory 208. The training module 604 assists in determining what levels of the hierarchical temporal memory 208 can access and the window of time to be processed at each level.

The warning control module 606 is software and routines for generating a warning signal. In one embodiment, the warning control module 606 defines one or more conditions of which the driver should be notified. Associated with each of these conditions is a type of alert to be signaled. Additionally, each of the conditions has an associated set, a warning set, of behavior types, trajectory types and short paths. Those skilled in the art will recognize that a condition may have as few as a single behavior type, trajectory type or short path; however, the accuracy of the warnings is improved where at least one behavior type and one trajectory type is associated with a condition. The warning control module 606 queries the hierarchical temporal memory 208 to determine whether there is a set of behavior types, trajectory types and short paths that match the associated set of behavior types, trajectory types and short paths that warrant notification. The warning control module 606 queries the hierarchical temporal memory 208 systematically, and in some cases on a periodic basis, to determine whether the hierarchical temporal memory 208 presently has any sets of behavior types, trajectory types and short paths that match warning conditions. If so, the warning control module 606 outputs a signal predefined for that condition.

The collision control module 608 is software routines for generating one or more control signals to control the primary vehicle to avoid a collision with other vehicles. The collision control module 608 is coupled by signal line 236 to the hierarchical temporal memory 208. In one embodiment, the collision control module 608 defines one or more collision sets and corresponding output control signals used to avoid a collision. Each of the collisions sets corresponds to a particular situation in which collision may be imminent but may be avoided. Each of the collision sets has an associated set of behavior types, trajectory types and short paths. As with the warning control module 606, there may be only one of a behavior type, trajectory type or short path in the associated collision set. The collision control module 608 queries the hierarchical temporal memory 208 to determine whether there is a set of behavior types, trajectory types and short paths that match any of the collision sets. The collision control module 608 queries the hierarchical temporal memory 208 systematically, and in some cases on a periodic basis, for the presence of any collision set. If a collision set is detected within the hierarchical temporal memory 208, the collision control module 608 outputs a corresponding group of control signals on signal line 126 to prevent collision.

The acceleration control module 610 is software routines for providing additional control signals to the adaptive cruise control 116. The acceleration control module 610 is coupled to signal line 236 to access the hierarchical temporal memory 208. The acceleration control module 610 has an output coupled to signal line 128 to provide the control signals to the adaptive cruise control 116. In one embodiment, the acceleration control module 610 defines one or more adjustment sets and corresponding output control signals to be sent to the adaptive cruise control 116. Each of the adjustment sets corresponds to a particular situation in which the adaptive cruise control 116 needs to be adjusted for the detected conditions of other vehicles. Each of the adjustment sets has an associated set of behavior types, trajectory types and short paths. Again, there may be only one of a behavior type, trajectory type or short path in the adjustment sets. Each of the adjustment sets also has a corresponding set of control signals suitable for output to correct or adjust the adaptive cruise control 116 for the condition detected. The acceleration control module 610 queries the hierarchical temporal memory 208 systematically, and in some cases on a periodic basis, for the presence of any set of behavior types, trajectory types or short paths matching the adjustment sets. If an adjustment set is detected within the hierarchical temporal memory 208, the acceleration control module 610 outputs the corresponding group of control signals on signal line 128.

### Methods

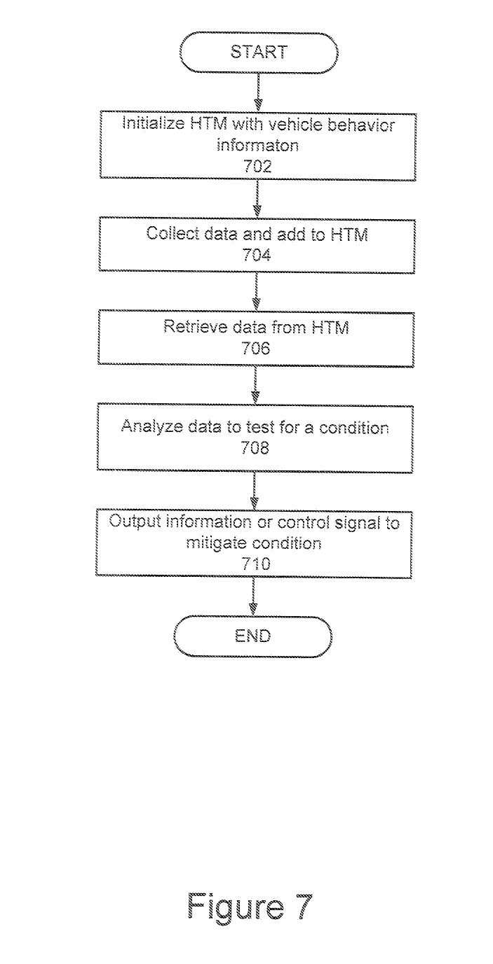

Referring now to FIG. 7, a method for predicting the behavior of other vehicles will be described. The method begins by initializing 702 the hierarchical temporal memory 208 with vehicle behavior information. As has been noted above, this can be done by using information from a database 102 by the initialization module 202. Next, the method collects data 704, processes the data such as using the transfer module 206 and stores the data in the hierarchical temporal memory 208. The step of collecting, processing and storing data in the hierarchical temporal memory 208 can be done repeatedly and independent of the remaining prediction steps. Next, method retrieves 706 data from the hierarchical temporal memory 208. For example, the data may be retrieved 706 by the warning control module 606, the collision control module 608 or the acceleration control model 610. Next, the retrieved data is analyzed 708 and tested to determine whether it matches any of the sets. For example, the data stored in long-term storage 302 and the intermediate-term stores 304 of the hierarchical temporal memory 208 are compared to the associated sets, collision sets or adjustment sets to determine whether there is a match. Finally, a respective module 606, 608 and 610 outputs 710 information or a control signal to mitigate the condition detected.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. A system for predicting behavior of other vehicles, the system comprising:
a sensor for sensing a condition, the sensor having an output for outputting signals representing different conditions;
a driver predictor for receiving information and maintaining a hierarchal temporal memory structure indicative of a current vehicle condition relative to the other vehicles, the driver predictor having an input and an output, the input of the driver predictor coupled to the output of the sensor, the driver predictor receiving signals from the sensor and converting them to data for storage in the hierarchal temporal memory structure; and
an output unit for generating an output signal related to the current vehicle condition, the output unit having an input and an output, the input of the output unit coupled to the driver predictor.

2. The system of claim 1 further comprising a database for providing historical information to initialize and update the driver predictor, the database adapted for communication with the driver predictor.

3. The system of claim 1 wherein the output unit is a notification unit and the output signal is a notification signal to warn of an imminent collision condition.

4. The system of claim 1 wherein the output unit is a vehicle control unit and the output signal is a control signal to control operation of the vehicle to avoid the imminent collision.

5. An apparatus for predicting behavior of other vehicles, the apparatus comprising:
a transfer module for processing data for storage, the transfer module having an input and an output, the input of the transfer module coupled to receive data;
a hierarchal temporal memory having an input and output for storing a hierarchical temporal model indicative of a current state of a vehicle and other vehicles proximate the vehicle, the input of the hierarchal temporal memory coupled to the output of the transfer module; and
a prediction retrieval module having an input and output for accessing and retrieving information from the hierarchical temporal memory, the input of the prediction retrieval module coupled to the output of the hierarchical temporal memory, the prediction retrieval module generating a signal for warning a driver or controlling the vehicle.

6. The apparatus of claim 5 wherein the transfer module receives real-time data, process the real-time data translates it into a form usable by the hierarchical temporal memory.

7. The apparatus of claim 5 further comprising an initialization module for retrieving data and providing the data to the hierarchal temporal memory for initializing the hierarchal temporal memory, the input of the initialization module coupled to retrieve historical information and the output of the initialization module coupled to input of the hierarchal temporal memory.

8. The apparatus of claim 5 wherein the hierarchal temporal memory includes a plurality of levels.

9. The apparatus of claim 5 wherein the hierarchal temporal memory further comprises:
a short term storage for storing short paths, the short term storage having an input and an output, the input of the short term storage couple to the output of the transfer module;
an intermediate term storage for storing trajectory types, the intermediate term storage having an input and an output, the input of the intermediate term storage coupled to the output of the short term memory; and
a long term storage for storing behavior types, the long term storage having an input and an output, the input of the long term storage coupled to the output of the intermediate term memory.

10. The apparatus of claim 9 wherein the hierarchal temporal memory further comprises:
an intermediate-to-long-term converter for converting one or more trajectory types to a behavior type, the intermediate-to-long-term converter having an input and an output, the input of the intermediate-to-long-term converter coupled to the intermediate term storage and the output of the intermediate-to-long-term converter coupled to the long term storage; and
a short-to-intermediate-term converter for converting one or more short paths into trajectory types, the short-to-intermediate-term converter having an input and an output, the input of the short-to-intermediate-term converter coupled to the short term storage, the output of the short-to-intermediate-term converter coupled to the intermediate term storage.

11. The apparatus of claim 5 wherein the prediction retrieval module further comprises a warning control module for generating a warning signal, the warning control module having an input and an output, the input of the warning control module coupled to the output of the hierarchal temporal memory, the warning control module querying the hierarchical temporal memory to determine whether there is stored information that matches a corresponding set of conditions that warrant notification.

12. The apparatus of claim 5 wherein the prediction retrieval module further comprises a collision control module for generating a control signal to control a primary vehicle to avoid a collision with other vehicles, the collision control module having an input and an output, the input of the collision control module coupled to the output of the hierarchal temporal memory, the collision control module querying the hierarchical temporal memory to determine whether there is stored information that matches a corresponding set of conditions that warrant output of the control signal.

13. The apparatus of claim 5 wherein the prediction retrieval module further comprises an acceleration control module for providing a control signal to an adaptive cruise control module, the acceleration control module having an input and an output, the input of the acceleration control module coupled to the output of the hierarchal temporal memory, the acceleration control module querying the hierarchical temporal memory to determine whether there is stored information that matches a corresponding set of conditions that warrant output of the control signal.

14. A method for creating an hierarchal temporal memory for use in prediction of collisions of vehicles, the method comprising:
receiving vehicle information;
processing the received information;
storing the processed information in a first level of the hierarchical temporal memory; and
processing information of the first level of the hierarchical temporal memory to generate data for storage in a second level of the hierarchical temporal memory.

15. The method of claim 14, the method further comprising repeating the step of receiving, processing and storing after a predetermined interval of time.

16. The method of claim 14, the method further comprising:
receiving historical vehicle behavior information; and
initializing the hierarchical temporal memory with the historical vehicle behavior information.

17. A method for predicting behavior of other vehicles using a hierarchal temporal memory, the method comprising:
providing access to the hierarchal temporal memory;
retrieving data from the hierarchal temporal memory;
analyzing the retrieved data for a match with an associated set; and
outputting a signal if there is a match between the retrieved data and the associated set.

18. The method of claim 17 wherein the step of analyzing compares data from a plurality of levels of the hierarchal temporal memory to corresponding levels in the data set.

19. The method of claim 17 wherein the associated set is one from the group of an warning set, collision set and adjustment set.

20. The method of claim 17 wherein the signal is one from the group of a warning signal and a control signal
